(19) United States
(12) Patent Application Publication
(10) Pub. No.: US 2017/0067453 A1
(43) Pub. Date: Mar. 9, 2017

(54) METHOD AND DEVICE FOR MODIFYING A CHARACTERISTIC OF A WIRE ELEMENT, PARTICULARLY THE DISTANCE SEAPARTING ITS TWO ENDS

(71) Applicants: UNIVERSITÉ PIERRE ET MARIE CURIE, PARIS (FR); CENTRE NATIONAL DE LA RECHERCHE SCIENTIFIQUE, PARIS (FR)

(72) Inventors: HERVÉ ELETTRO, PARIS (FR); ARNAUD ANTKOWIAK, GENTILLY (FR); SÉBASTIEN NEUKIRCH, NEMOURS (FR); FRITZ VOLLRATH, OXFORD (GB)

(21) Appl. No.: 15/307,822

(22) PCT Filed: Apr. 30, 2015
(86) PCT No.: PCT/FR2015/051163

§ 371 Date: Oct. 29, 2016

(30) Foreign Application Priority Data
Apr. 30, 2014 (FR) 1453960

(51) Int. Cl. F03G 7/06; D06M 23/16; D06M 23/14; D02G 3/00; D02G 3/04

(52) U.S. Cl. CPC F03G 7/06; D02G 3/00; D02G 3/04; D06M 23/14; D06M 23/16

(57) ABSTRACT

A device including a wire element and a winding element to wind the wire element. The winding element is configured to change from a first stable state to a second stable state. A change in the state occurs either naturally or by changing an environment parameter so as to result in the wire element being wound on the winding element. In the naturally occurring state change, the energy of interaction between the wire element and the environment is higher than the energy of interaction between the wire element and the winding element. The environment parameter change results in the wire element being wound on the winding element during the change from the first state to the second state.

This invention relates to a method and a device for its implementation, which makes it possible to modify at least one characteristic of a wired element, particularly the distance separating its two ends, and is equipped with a means to wind said wire element.

Some materials have exceptional properties. For example, KEVLAR® offers very useful breaking strength. That thermoplastic polymer has breaking strength of about 3100 MPa. However, it is not very elastic or extensible and breaks fairly easily if compressed or buckled.

Conversely, material such as rubber is variably elastic. For example, an elastomer can withstand up to 200% extensibility before breaking. On the other hand, this type of material is not very resistant in the event of an impact.

For its part, a biomaterial such as spider silk can bring together several particular properties such as adaptability, extensibility and breaking strength. However, it is very difficult to produce, making the use of such materials virtually non-existent.

The invention is aimed at addressing the issues described above by proposing a device and a method to make a device that can be easily mass-produced and combines several particular properties.

To that end, according to the invention, the device comprises a wire element and a means to wind the element that is associated with said wire element, and is characterized in that the winding means is adapted to change from a first stable state to a second stable state, wherein that change in state occurs:

either naturally, so that the energy of interaction between the wire element and the environment is higher than the energy of interaction between the wire element and the winding means, or

by changing a parameter known as an environment parameter, so as to result in the wire element being wound in said means during the change from the first state to the second state.

A stable state is defined as a state to which the system returns naturally if it is disturbed by an outside event. A stable state is one where the system shows the least energy.

‘Naturally’ and ‘chemical affinity’ refer to the fact that the energy of interaction between the wire element and the environment is higher than the energy of interaction between the wire element and the winding means. Such favorable interaction may be due to molecular resemblances (carbon/silica chains, hydrogen bond etc.) so that the energy of the wire element and the winding means taken separately is greater than the energy of the wire element and the winding means in interaction.

The invention, by associating a wire element and a winding means, each having its own function, creates a new function.

In a particular embodiment of the invention, the winding means is a liquid drop.

The invention makes it possible to create a hybrid mechanical assembly between liquid and solid, and thus obtain a material that is adaptable under pressure and shows high tensile rigidity.

That is the case, for example:

of a wire element made of polyurethane in interaction with a winding means made of silicone oil in an environment made up of air. In this case, the energy of interaction between the wire element and the environment is 37.8 mJ/m², while the energy of interaction between the wire element and the winding means is 20.9 mJ/m²

or a wire element made of glass in interaction with a winding means made of water in an environment made of air. In this case, the energy of interaction between the wire element and the environment is 4.4 J/m², whereas the energy of interaction between the wire element and the winding means is 4.33 J/m².

The invention further relates to a method for changing at least one mechanical property such as the rigidity of the curvature of a wire element, characterized in that it is associated with at least one body in fluid (liquid, gaseous) or solid material, and in that at least one characteristic of the material of said body is changed.

If a parameter known as an environment parameter of the environment in which the winding means and wire element are placed is modified, the modification may relate to a parameter such as the ambient air pressure, the temperature, the intensity or direction of electric field, the intensity or direction of magnetic field, making the wire element buckle under mechanical stress, or any other parameter that is suitable for influencing the system, so as to wind the wire element around said body. Thus, by changing one of the parameters intrinsic to the wire element and/or a parameter known as an environment parameter, the phenomenon of the capillary winch may be applied. Capillary winch refers to the phenomenon consisting in winding up the wire element in the winding means, which may be a body in fluid or solid material.

Mechanical stress is the ratio between the force applied to an object and the section of the object measured perpendicular to the direction of the force. The concept of mechanical stress is used to represent the influence of an external force on an object independently of its size.

To bring about this particular phenomenon, the wire element and the winding means may have affinities, defined for example by their sizes, their chemical affinities or their size or weight relationship. That is because, to mention only a non-limitative example, the diameter of the wire element must be sufficiently small to allow winding by means of the winding means, in or around the means. ‘Small’ means a wire with a radius smaller than three times the radius given by the equation below.

Characteristics of the wire element and winding means:

The size of the wire element in relation to the winding means is an important characteristic for activating the capillary winch phenomenon. The wire element may for instance have a diameter that is smaller than or equal to a centimeter, preferably between 0.1 micron and 1 cm, advantageously below 10 microns. The dimensions of the winding means will then depend on the dimensions of the wire element. In a particular embodiment of the invention, the winding means is a drop of liquid. The diameter of the section of the wire element is then determined by the relation:

$$Winding if r \leq {r}_{crit} = 1.31 \times \frac{( γ cos θ ) 5 / 7}{( pg ) 2 / 7 E 3 / 7} ≅ 5.5 µm for$$

$$water on {NYLON}^{®}$$

γ: surface tension

θ: contact angle

ρ: liquid density

E: Young's modulus

The invention aims to obtain a fiber with a radius smaller than that defined by the equation, using a method specific to each material. Then the fiber is associated with a liquid that has wettability characteristics in relation with said equation, for example by removing the fiber from a bath of that liquid or by vaporizing the liquid.

A fiber is now considered to be fine if its radius is smaller than three times that given by said equation.

As non-limitative examples, the material making up the winding means may be tin, wax, silicone, water or any liquid that wets the wire element, if the winding means is a drop of liquid. The wire element may be made of metals, elastomers or polymers such as polyurethane, synthetic rubber, nylon fibers, KEVLAR® fibers, carbon fibers, deformable steel, glass fibers, elastic plastic (which retains part of the deformations applied to it), highly deformable material or any material that can be obtained in fine fibers, and advantageously fibers with a diameter below 10 microns.

In a particular embodiment of the invention, the winding means is a drop of liquid. In this particular embodiment, the drop of liquid that makes up the winding means must be compatible with the wire element. As an example, the drop must wet the wire element and must spread as widely as possible on the wire element. The effective contact angle between the wire element and the drop is then less than 90°. The drop may already be in liquid state or be obtained from a solid material, changed into a liquid state, particularly by heating. In this particular embodiment, the environment parameter is the temperature. The temperature corresponding to the first stable state of the winding means may be ambient temperature, 20° C. for example. The temperature in the second stable state making it possible to wind the wire element may range from the melting temperature to the boiling temperature of the liquid used. In this particular embodiment of the invention, several liquid drops or several wire elements may be combined to boost the effects of the invention.

In a particular embodiment of the invention, the parameter known as the environment parameter is an electric field. In this particular embodiment, at least one characteristic of the winding means (contact angle, capillary compression force) or the wire element (for example thickness if it is an electroactive polymer) is changed.

The change of state is reversible.

Said parameter is, in one example,

the temperature (in one particular form, the temperature in the second modified state, which winds the wire element, ranges from 30 to 80° C. and preferably from 50 to 70° C.);

an electric field;

the addition to the body of a substance that modifies its wettability.

Said body is a drop of wetting liquid or a partial wetting liquid with a contact angle below 90°.

The material making up the winding means has one or more of the following characteristics:

a glass transition temperature ranging from 30° C. to 80° C., preferably from 45 to 65° C.;

a change of viscosity above the ambient temperature:

is tin, wax, silicone.

The wire element:

has a diameter smaller than or equal to a centimeter, preferably from 0.5 micron to 1cm, preferably from 1 micron to 100 microns, and even more preferably from 1 micron to 10 microns; and/or

has characteristics, firstly the Young's modulus (E) and secondly the radius (r), such that: E r³<300, where ‘E’ is expressed in MPa and ‘r’ in microns;

is made of polyurethane, synthetic rubber, nylon fiber, KEVLAR® fiber, carbon fiber, high-elasticity steel, elastic plastic, superelastic material.

The dimensional ratio between the diameter of the wire element and the diameter of the block or the drop ranges between 0.0125 and 0.05.

Materials known as ‘high-elasticity’ or ‘superelastic’ materials are materials that are capable of being highly deformed before they reach their breaking point. Glass, for example, undergoes 0.5% deformation before breaking. For their part, superelastic materials are much more deformable, at least 5% (before breaking).

The diameter of the drop ranges between 1 micron and 1 cm.

The diameter of the winding means is below 3 mm.

The diameter of the winding means ranges from 20 to 80 times the radius of the wire element, preferably 45 to 55 times the radius.

The invention also relates to the application of the device above to make up a motor, an activator, an actuator, an artificial muscle, a means to move an object in relation to another object (wherein the objects are linked at the two respective ends of said wire element), a series of electrical or electronic joints of variable length, explained in the description below.

Further, the invention relates to a method aimed at providing the drop of liquid with means for protection from external attacks, mechanical or otherwise.

To that end, the drop is encapsulated in an enclosure formed of a multitude of solid grains, with sizes that are 1/50th or preferably 1/100th of the latter, wherein the grains cover the outer surface of the drop, or at least most of it, preferably the totality of the surface of the drop.

More precisely, the grains are formed of colloids, are micrometric in size, and may for example be made of glass, polystyrene or any other material with the required wetting properties, that is to say the energy of interaction between the grains and the drop must be of the same approximate magnitude as the energy of interaction between the grains and the outer environment.

The invention will be better understood in the light of the description below, by reference to the accompanying drawings wherein:

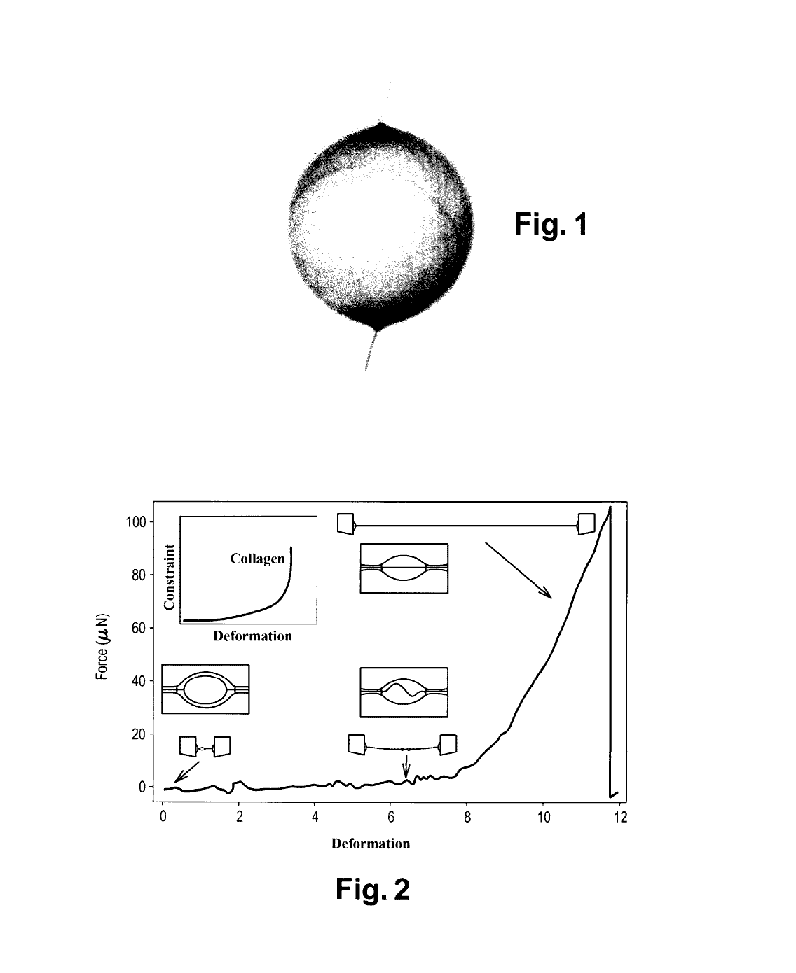

FIG. 1 shows a top view of a drop of liquid and a polyurethane wire wound up inside the drop.

FIG. 2 shows the variation curve of the elongation of a wire of spider silk as a function of the tensile force,

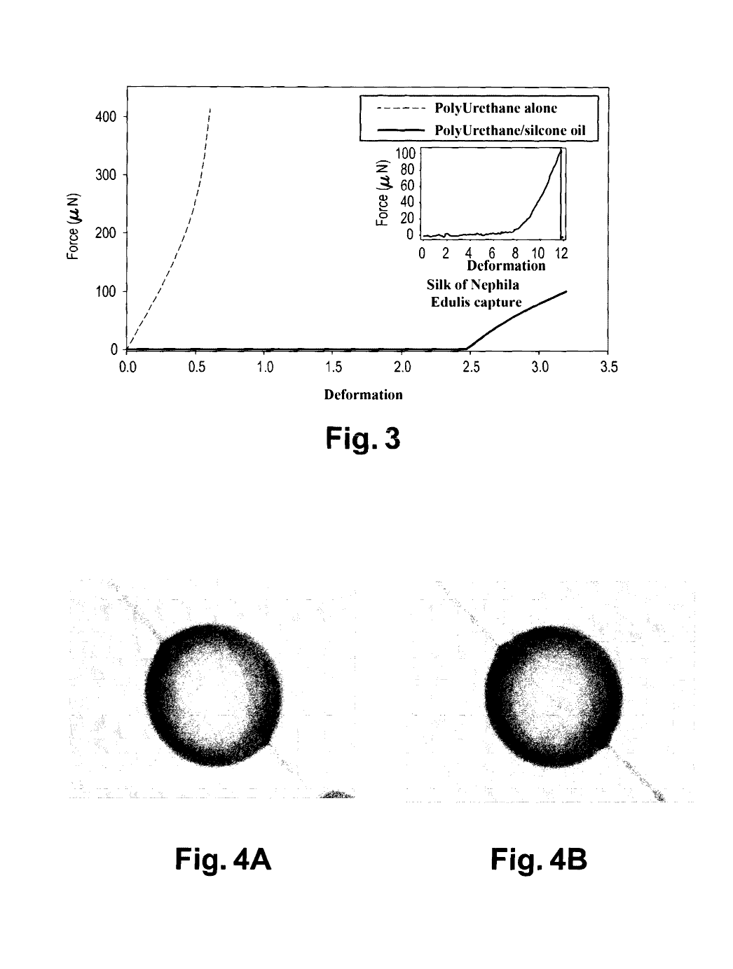

FIG. 3 shows the tensile curve of a polyurethane wire with a drop (dotted curve) and without a drop (solid curve).

FIGS. 4A and 4B are photographs showing a drop and the associated wire, at the ambient temperature and at 75° C. respectively.

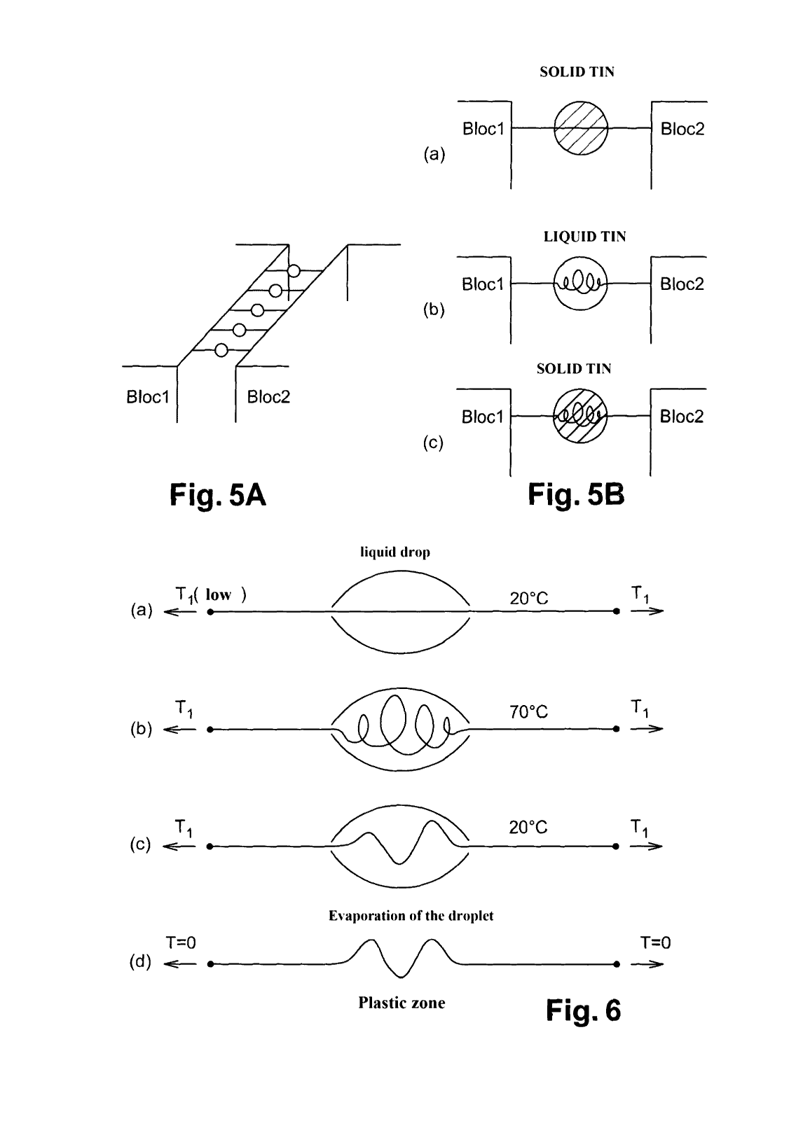

FIGS. 5A and 5B are schematic perspective views of another exemplary implementation of the method according to the invention.

FIG. 6 shows the particular application of the device to create a spring.

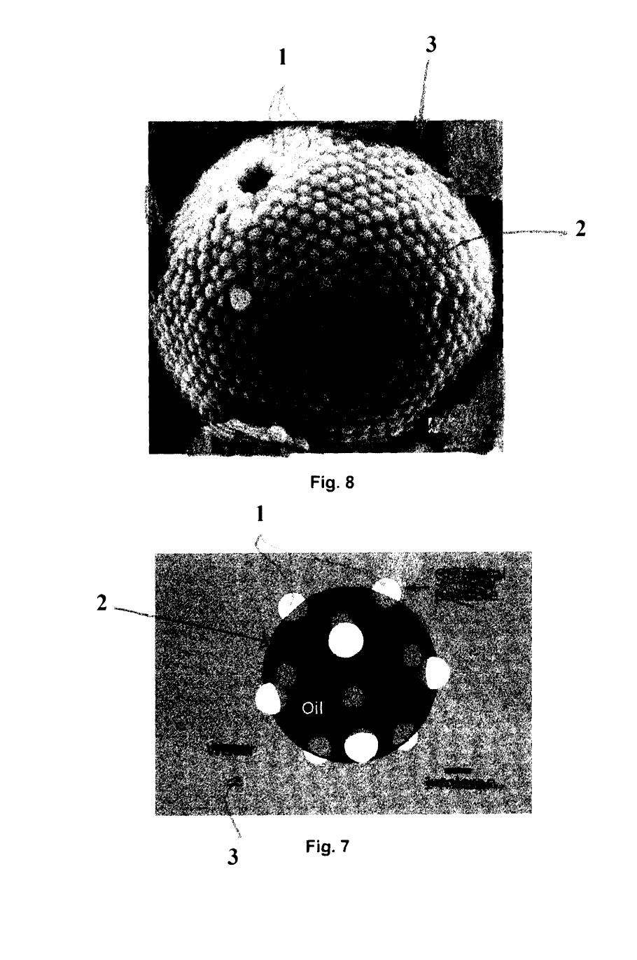

FIG. 7 shows a schematic front view of a drop with encapsulating grains on its surface, placed in a liquid;

FIG. 8 shows a photograph of a drop covered with encapsulating grains.

The method and device according to the invention use the following concepts:

When you pull a spring with an unloaded length of L₀, the spring elongates, and its longer length is L. The L-L₀ extension is proportional to the tensile force F.

The fiber used in the invention may be superelastic. ‘Superelasticity’ is a term used in the area of shape-memory alloys (SMAs). If such an alloy is subjected to a tensile force, it stretches greatly, then, if the tensile force is released, it retracts till it goes back to its initial length (no residual deformation). The particular mechanical behavior of SMAs is due to a change of phase in the microstructure of the material.

FIG. 1 shows a particular embodiment of the invention where the drops are capable of bending and winding the wire within themselves. The drops placed on the wire locally compress the wire by capillary contraction. That capillary compression is due to the fact that the drop tends to adopt a spherical shape, which minimizes its surface with its environment. If the compression is sufficiently high, the fiber present in the drop can be bent, or even be wound up in the drop, thus creating a ‘capillary winch’. For example, the tensile curve of a wire of spider silk, which is considered to be the biological material that is of the greatest usefulness to reproduce, is given in FIG. 2. This curve shows that the wire can be stretched significantly. That high extensibility comes from the reserve wire present in the drops, thanks to capillary winding. The extension rigidity is adaptable: with small deformations, rigidity is virtually nil, and the wire is merely unwound. With greater deformation values, the wire starts to be truly stretched, and shows rigidity comparable to a material such as Nylon®. That tensile curve resembles that of a material such as collagen. That is particularly useful in biological applications, where there is a need for adaptable material with a mechanical response that changes with deformation.

This invention uses that phenomenon, with, for example, synthetic fibers, providing the fiber is sufficiently small to be bent, and the liquid making up the drop is sufficiently wetting. This phenomenon can thus be reproduced with a wide range of materials and liquids.

In a particular embodiment of the invention, the wire element is made of soft polyurethane wire, which is a common and inexpensive commercial polymer. The polyurethane is melted, extruded at high speed to form a fiber with a size measured in microns. A drop of silicone oil is paced on that fiber, and the capillary winch phenomenon occurs automatically, see FIG. 1. A wire is then obtained, associated with drops of silicone oil, which can be stretched to over twenty times its initial length with a constant force. Further, the wire is tensioned automatically regardless of the extension; there is no gravity sag. Retention under compression means that it remains taut when its ends are brought closer. Lastly, the drops give it very high damping power (shock absorption, vibration damping etc.). FIG. 3 shows that the polyurethane wire associated with the drops qualitatively reproduces the mechanical properties of spider silk (retention under compression, adaptable rigidity and excellent damping). The wire/drop assembly has a mechanical response that is typical of a biological material, even though it is completely artificial. FIG. 3 shows the tensile curve of a polyurethane wire with a drop (dotted curve) and without a drop (solid curve). The solid curve shows the intrinsic mechanical properties of the polyurethane wire, similar to those of classic elastomer such as a band of rubber. The dotted curve shows the high extensibility (multiplied by a factor of 4) of the wire when it is decorated with drops, and its adaptable rigidity.

Particular case: thermal activation of the phenomenon: polylactic acid (PLA).

The rigidity of the curvature of a wire depends on its thickness and its natural elastic rigidity when extended (Young's modulus). The Young's modulus is modified to trigger the winch mechanism at will. A PLA wire with a Young's modulus of about a Giga Pascal (GPa), and a diameter of 1 to 3 microns is used. Such a wire, when associated with drops of silicone oil, is not affected by the winch mechanism because it is too rigid. When it is heated to 75° C. (critical glass transition temperature of the polymer—glass transition being the transition that separates a vitreous state such as glass (rigid and brittle) and a rubbery state (soft and extensible)), the rigidity of the wire is divided by 1000 and the winch phenomenon then occurs directly. When it drops below the critical temperature, the winding is ‘frozen’ (see paragraph ‘Possible applications’ below). The temperature can thus be used as a command or switch to control the winch phenomenon. Similarly, the use of drops of melted tin (the melting temperature of which is around 200° C.) could make it possible to thermally activate the phenomenon or freeze the winding.

The device according to the invention is simple to implement, to give conventional materials extreme mechanical properties such as super extensibility, length adaptability (smart meta materials), excellent damping and perfect reversibility (no plasticity or fatigue).

Another mode of use of the device is described by reference to FIGS. 5A and 5B.

In this particular mode, drops of tin (or wax or any material that can be liquefied easily) are used to move microsystems (translationally). Two blocks or objects that are part of a microsystem are to be brought closer (FIG. 5A). They are joined by metal wires, which wires are associated with small pieces of solid tin according to the invention. The tin is liquefied (using a laser or the Joule effect—heating of the wire when an electric current passes through it). The winch mechanism described above is activated and the blocks are brought closer to each other. Once the translation is complete, the tin can be solidified once again and the system is thus blocked in the close position.

By changing (even slightly) the mechanical properties of the wire and the material making up the body forming the drop, the coupling between the fiber and the drop carried by it can have an avalanche effect and completely modify the overall mechanical properties. It is therefore possible to move from a conventional material to a material with exceptional properties, adaptable under the effect of external stimuli, even small ones: the temperature influences the rigidity of the fiber, an electric field has influences on the capillary winch effect of the drop, or surfactants which can respond to a number of external stimuli such as luminous, thermal or electrical activation. However, it is also possible and simple to use parameters that make the mechanical properties long lasting, such as in the non-limitative example of the solidified drop of tin.

The great freedom in respect of the parameters involved (drop and fiber sizes, rigidity of the fiber and the liquid making up the drop) in turn allow great freedom for the adjustment of new mechanical properties.

The materials thus created can be applied in the following areas:

1. Flexible electronics/nanoelectronics

2. Nanorobotics

3. Compact 3D micro manufacturing, deployable and self-organized

4. Artificial muscles

5. Perfect motor/micro actuator

The applications named above are not limitative in any way and other easily imaginable applications can of course be envisaged with this type of device.

In electronics, a conductive metal wire can thus be created, with mechanical properties that are made adaptable by the method of the invention. The wire, where the electronic joints between components become extremely deformable, makes it possible to create objects that can be deployed by 10,000%, against 10% in known applications.

In robotics, the wire/winding means (drop) assembly may be used as a motor. That is because by winding the wire using the winch effect, the drop applies driving force on the wire, which can then be applied to an outside system. That could also act as an actuator or motor, which may be switched on and off at will (reversible phenomenon). One very useful aspect of this motor/actuator is that no material is physically stretched during the low-deformation elongation, which allows perfect reversibility of the motor, and thus a life span that is far longer than with conventional materials that show plasticity. This invention can also limit fatigue, phenomena that limit performance and ultimately lead to a break

In micro manufacturing, the actuator system may be used to create a permanent local winding of the wire, when the drop is removed: if a drop is placed on a rigid fiber, then its temperature is raised, the wire is then wound up in the drop and when the temperature decreases, the winding is ‘frozen’. A 3D object with a complex geometry is thus created simply (see FIG. 6). For plastic materials, the change of a parameter known as an environment parameter is not a necessity. Winding can take place naturally due to the affinity of the wire element and the winding means; however, the performance will be reduced.

Similarly, several wire elements may be combined, particularly to create an artificial muscle. That is because you only need to attach a large number of wire elements/winding means that can be activated between two surfaces to boost the effects of the invention and obtain an artificial muscle fiber.

Lastly, the invention may be used to create springs or complex three-dimensional objects such as a micro-coil. That is because it is easily imaginable to create a winding, for example with a drop of liquid (non-limitative case). That drop of liquid, which has affinity with a wire element, will thus allow the wire element to be wound inside the drop. Once it is wound up, the user may decide to remove the drop, for instance by means of a pipette, or remove the drop without contact, by blowing it or applying an intense pulsed electric field. The wire element would thus be in the ‘wound’ state and a spring could thus be created. For that winding to be stable, the wire element must however have undergone permanent deformations, either via the procedure described above, in the ‘micro manufacturing’ paragraph, or by plasticizing. (FIG. 6)

It will also be possible, in the particular embodiment of the invention where the winding means is a drop, to encapsulate that drop. Such encapsulation could be physical, through the construction of a non-wetting cage for the drop (non-limitative example) or chemical, by using viscoelastic fluids, which have the property of behaving like solids in the event of rapid contact, and thus do not spread.

As a non-limitative example, the wire element may have the following characteristics:

Maximum reduction of the initial length of a wire obtained with a sample with an 8.4 mm length, reduced to 1.7 mm after winding, or a length reduction by a factor of 80%. That was achieved with a single drop of Rhodorsil 47V1000 silicon oil with a diameter of 167 microns, winding 6.7 mm within it, or 40 times its size (12.5 turns).

Young's modulus of the fiber used: 12+/−1 MPa.

Fiber radius: 2.3+/−0.2 microns.

The wire element is an Elastollan fiber.

The known Elastollan sample (with no drop) has extensibility at break of +530%, while the same sample associated with a drop of silicone oil (according to the invention) shows extensibility at break of over 3000%.

The wire was produced as follows:

A few granules of Elastollan 1185A TPU were placed on a heating plate covered with aluminum foil, and set to 230° C. When the TPU melts, part of it is pinched and stretched as rapidly as possible by the operator, thus creating several meters of micron fibers. A part that appears homogenous is selected, and the fiber is wound at one end around the FemtoTools FT-S1000 sensor mounted on a SmarAct SLC-1730 linear positioner and glued with LOCTITE® or SuperGlue type glue to a glass slide at the other end.

A drop of Rhodorsil 47V1000 silicon oil hangs from the end of a syringe with a diameter of 0.4 mm, and the fiber is brushed lengthwise in order to deposit a large quantity of liquid.

The typical dynamic reaction time of the system is about 100 ms.

FIG. 3 shows the variations in the tensile force as a function of the strain in the system. Strain is defined as (L-L₀)/L₀. The mechanical response of the system according to the invention can be seen in FIG. 3: the tensile force as a function of strain in the system. Strain is defined as (L-L₀)/L₀ where L₀ is the length of the system at the start when a large quantity of fiber is wound in the drop or drops. The dotted lines represent the response to the system showing superelasticity: the length is multiplied by 3.5 (deformation or strain=2.5) before it reaches the zone where spring type stiffness can be felt. The solid lines show the response of a fiber in the absence of a liquid drop, for the purpose of comparison. In that case, there is no length reserve and the system responds immediately like a spring. It can thus be seen that the fiber according to the invention (associated with a drop) has a great extensibility reserve. The insert shows the mechanical response of a spider silk fiber for the purpose of comparison. The wire/drop assembly according to the invention typically has the same mechanical properties as spider silk wire, while avoiding the difficulties of synthesizing spider silk and characterizing the natural liquid drops present on the spider silk.

FIGS. 4A and 4B are photographs showing a drop and an associated PLA wire, at the ambient temperature and at 75° C. respectively.

In order to better illustrate the results of FIGS. 4A and 4B, the PLA used for these figures has the following characteristics:

Young's modulus of PLA: 5 GPa at ambient temperature, 70 MPa at 75° C.

Glass transition temperature: 60° C.

Radius of the wire used: 1.7 microns (same technique as for TPU, only a metal nozzle is used for extrusion instead of the simple heating plate).

Size of the drop of 47V1000 silicone oil: 217 micron diameter.

Number of turns given: 2.5 turns (i.e. 8 times the size of the drop).

In another aspect of the invention, by reference to FIGS. 7 and 8, the invention relates to a method that makes it possible to give the drop of liquid means for protection from external attacks, mechanical or otherwise.

Said method encapsulates the drop in an enclosure formed of a multitude of grains, each formed of a liquid different from that of the drop, with a size that is 1/50th, preferably 1/100th of the size of the drop. The multitude of grains covers the outer surface of the drop, preferably entirely.

More precisely, the grains are formed of colloids, are micrometric in size, and may for example be made of glass, polystyrene or any other material with the required wetting properties, that is to say

the energy of interaction between the grains and the drop must be approximately similar in magnitude to the energy of interaction between the grains and the outer environment.

The procedure is as follows (FIG. 7):

The grains 1 are mixed with a first liquid, for example oil, then a drop 2 formed with the mixture is placed in a second liquid 3, for example water.

In FIG. 7, only a few grains have been shown for clarity, but it is understood that the totality of the surface of the drop is covered with grains.

FIG. 8 is a photograph of a drop covered with grains, according to FIG. 7.

The grain encapsulating method is used because it offers the benefit of protecting the drop without compromising its liquid nature. That is because unlike a solid shell, the grains can move and reorganize on the surface of the drop. Those skilled in the art can refer to the publication: Aussillous, Pascale, and David Quéré. “Liquid marbles.” Nature 411.6840(2001):924-927.

Thus, objects with sizes similar to grains could penetrate inside the drop as if the drop was not protected. On the other hand, objects that are larger than the grains would be kept at a safe distance. That makes it possible to pass a wire inside the drop and retain the capillary winch system, while providing resistance to impacts against surfaces.

1-10. (canceled)

11. A device comprising a wire element and a winding element to wind the wire element, the winding element is configured to change from a first stable state to a second stable state to result in the wire element being wound in the winding element, wherein a change in the state occurs either naturally when an energy of interaction between the wire element and an environment is higher than the energy of interaction between the wire element and the winding element, or by changing an environment parameter to result in the wire element being wound in the winding element during the change from the first stable state to the second stable state.

12. The device according to claim 11, wherein the wire element has a diameter ranging between 0.1 micron and 1 cm.

13. The device according to claim 12, wherein the diameter of the wire element is below 10 microns.

14. The device according to claim 11, wherein the winding element is made of one of the following material: tin, wax, silicone, water or a liquid that wets the wire element.

15. The device according to claim 11, wherein the wire element is characterized in that the wire element is made of one of the following material: metals, elastomers, polymers, or a material that can be obtained in fibers; and wherein the polymers are one of the following: polyurethane, synthetic rubber, nylon fibers, KEVLAR fibers, carbon fibers, high-elasticity steel, glass fibers, elastic plastic or superelastic material.

16. A method for changing at least one mechanical property of a wire element, the wire element is associated with at least one body in a liquid fluid, a gaseous fluid, or a solid material; and at least one of the following is changed so as to result in the wire element being wound in or around said body: at least one characteristic of a material of said body and an environment parameter of an environment in which a winding element and the wire element are placed.

17. The method according to claim 16, wherein the environment parameter is one of the following: a temperature, an intensity or direction of an electric field, an intensity or direction of a magnetic field, or a mechanical stress.

18. The method according to claim 16, wherein the body is a drop of a liquid.

19. The method according to claim 16, wherein the body is a bubble of a gas.

20. The method according to claim 18, further comprising the step of encapsulating the drop of the liquid in an enclosure formed of a plurality of solid grains to protect the drop of the liquid from external attacks, a size of each grain being 1/50th of a size of the drop of the liquid; and wherein the plurality of solid grains cover an outer surface of the drop of the liquid.

21. The method according to claim 20, wherein the size of each grain is 1/100th of the size of the drop of the liquid.

22. The method according to claim 20, wherein the plurality of the solid grains covers a total outer surface of the drop of the liquid.

23. The method according to claim 20, wherein the enclosure is configured to proect the drop of the liquid from external mechanical attacks.

24. The device according to claim 11 is configured to make up a motor, an activator, an actuator, an artificial muscle, an apparatus configured to move two objects or assemblies linked at the two respective ends of the wire element, a series of electrical or electronic joints of variable length or a spring.
